(19) United States
(12) Patent Application Publication
(10) Pub. No.: US 2024/0401390 A1
(43) Pub. Date: Dec. 5, 2024

(54) DOUBLE-SHAFT HINGE WITH SINGLE-SHAFT IMPLEMENTATION MODE

(71) Applicant: Sinher Technology Inc., New Taipei City (TW)

(72) Inventors: Feng-Yu CHUNG, New Taipei City (TW); Chih-Huang PENG, New Taipei City (TW)

(21) Appl. No.: 18/327,727

(22) Filed: Jun. 1, 2023

(51) Int. Cl. E05D 11/10; E05D 3/12; E05D 5/12

(52) U.S. Cl. CPC E05D 11/1014; E05D 3/122; E05D 5/128

(57) ABSTRACT

A double-shaft hinge with a single-shaft implementation mode includes a base, two shafts on the base, and a driving member for enabling the two shafts to synchronously rotate. One of the two shafts is provided with a switching member and a connecting member, the switching member is configured to drive the corresponding shaft to rotate. The switching member is limited to move between the connecting member and the base, the switching member has two first concave-convex portions positioned at two ends, the connecting member includes a second concave-convex portion which faces the switching member and can be engaged with one of the two first concave-convex portions, and the base includes a third concave-convex portion which faces the switching member and can be engaged with the other first concave-convex portion. The double-shaft hinge switches between a single-shaft implementation mode and a double-shaft implementation mode based on the switching member.

### FIELD OF THE INVENTION

The present invention relates to a double-shaft hinge, and particularly relates to a double-shaft hinge with a single-shaft implementation mode and a double-shaft implementation mode.

### BACKGROUND OF THE INVENTION

Double-shaft hinges generally achieve 360-degree opening by one of the following: double-shaft switching rotation or double-shaft synchronous rotation, and there is no change in the rotation mode in the implementation process, which also results in that the double-shaft hinges cannot be implemented according to special requirements nowadays, for example, only single-shaft rotation is achieved in the initial implementation of the double-shaft hinge, and changed to double-shaft synchronous rotation after a certain angle.

China Patent Publication No. CN111720427A discloses a double-screen pivot device. Although the double-screen pivot device has two shafts, the mode of switching rotation is still maintained during rotation, that is, 360-degree rotation is still spliced by multiple sections of single-shaft rotation states in this case, there is still no technical content of changing the rotation form of the hinge, and therefore the implementation according to special requirements cannot be achieved.

### SUMMARY OF THE INVENTION

A main object of the present invention is to solve the problem that the conventional double-shaft hinge has a single form of implementation and cannot be adapted to special implementation.

In order to achieve the above object, the present invention provides a double-shaft hinge with a single-shaft implementation mode. The double-shaft hinge includes a base, two shafts arranged on the base in parallel, and a driving member synchronously rotating the two shafts. For the double-shaft hinge, one of the two shafts is provided with a switching member and a connecting member, the switching member is provided for driving one of the two shafts, on which the switching member is positioned, to rotate, the switching member is limited to move between the connecting member and the base, the switching member includes two first concave-convex portions positioned at two ends thereof and respectively facing the connecting member and the base, the connecting member includes a second concave-convex portion facing the switching member and matched with one of the two first concave-convex portions, and the base includes a third concave-convex portion facing the switching member and matched with the other of the two first concave-convex portions. The double-shaft hinge includes a single-shaft implementation mode and a double-shaft implementation mode, in the single-shaft implementation mode, the connecting member is only rotated relative to one of the two shafts when one of the two first concave-convex portions is buckled with the third concave-convex portion; and in the double-shaft implementation mode, the two shafts are synchronously rotated when one of the first concave-convex portions is buckled with the second concave-convex portion.

In an example, one of the two shafts provided with the switching member includes a non-circular section assembled and connected with the switching member, and the switching member includes a non-circular hole corresponding to the non-circular section.

In an example, the double-shaft hinge includes two first torsion generating groups respectively arranged on the two shafts, and a second torsion generating group arranged on one of the two shafts provided with the switching member.

In an example, the two first concave-convex portions, the second concave-convex portion, and the third concave-convex portion are respectively provided with one of the following: at least two bumps and at least two grooves.

In an example, each of the at least two grooves includes a guide inclined surface, a groove bottom surface connected to the guide inclined surface, and a blocking surface connected to the groove bottom surface.

In an example, the driving member is a spiral gear, and each of the two shafts includes a threaded section matched with the driving member.

In an example, the connecting member includes a plurality of plates, and the second concave-convex portion is formed on one of the plurality of plates facing the switching member.

In an example, one of the plurality of plates provided with the second concave-convex portion further includes a driving portion for driving the other adjacent one of the plurality of plates, and the other adjacent one of the plurality of plates assembled and connected with the driving portion includes a mounting portion.

Through the foregoing implementation of the present invention, the present invention has the following characteristics compared with the conventional double-shaft hinge: by changing the state of the switching member when the double-shaft hinge is at different opening angles, the double-shaft hinge can be switched between the single-shaft implementation mode and the double-shaft implementation mode, the single-shaft implementation mode can be achieved in the initial opening of the double-shaft hinge, and the double-shaft implementation mode can be continued after opening at a certain angle, so as to meet special implementation requirements.

### BRIEF DESCRIPTION OF THE DRAWINGS

FIG. 1 is a perspective view of a structure of a double-shaft hinge according to the present invention.

FIG. 2 is an exploded view of the structure of the double-shaft hinge according to the present invention.

FIG. 3 is a side view of the structure of the double-shaft hinge according to the present invention.

FIG. 4 is a schematic view of the structure of the double-shaft hinge according to the present invention at 0 degree.

FIG. 5 is a schematic view of the structure of the double-shaft hinge according to the present invention at 120 degrees.

FIG. 6 is a schematic view of a position of a switching member when the double-shaft hinge according to the present invention in a single-shaft implementation mode.

FIG. 7 is a schematic view of the position of the switching member when the double-shaft hinge according to the present invention in a double-shaft implementation mode.

FIG. 8 is a schematic view of the structure of the double-shaft hinge according to the present invention at 220 degrees.

FIG. 9 is a schematic view of the structure of the double-shaft hinge according to the present invention at 360 degrees.

### DETAILED DESCRIPTION OF THE PREFERRED EMBODIMENTS

The detailed description and technical contents of the present invention are now described with reference to the accompanying drawings as follows.

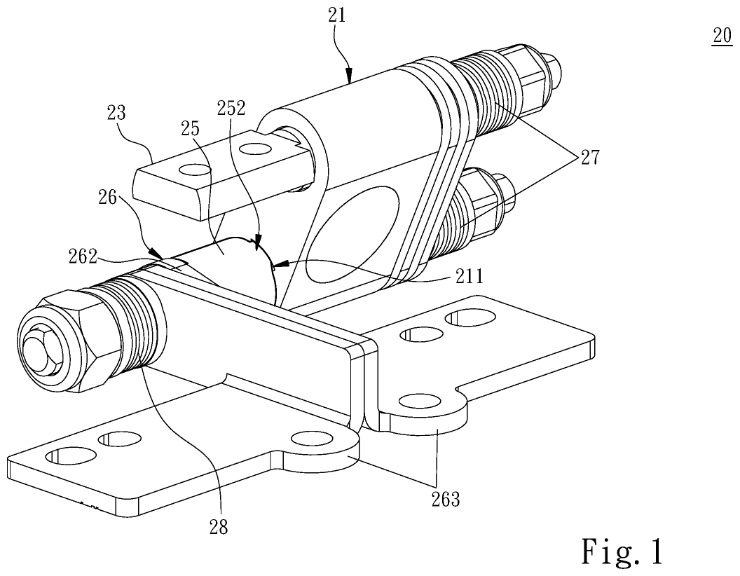

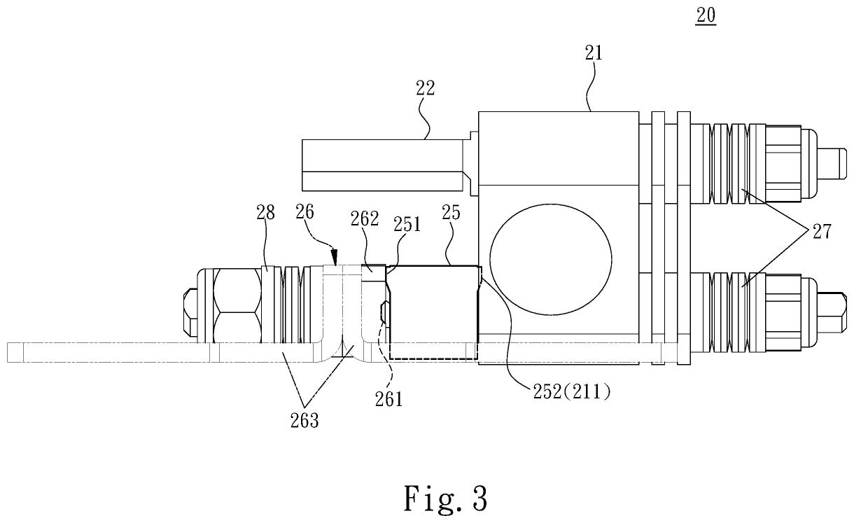

Referring to FIG. 1 and FIG. 3, the present invention provides a double-shaft hinge 20. The double-shaft hinge 20 includes a base 21, two shafts 22, 23 arranged on the base 21 in parallel, and a driving member 24 synchronously rotating the two shafts 22, 23. Further, for the double-shaft hinge 20 provided by the present invention, one of the two shafts 22, 23 is provided with a switching member 25 and a connecting member 26, wherein the switching member 25 is a tubular structure, and the switching member 25 is switched during the implementation of the double-shaft hinge 20, but also provided for driving one of the two shafts (22) to rotate. According to the present invention, the switching member 25 is not fixedly arranged in on one of the two shafts (22), the switching member 25 moderately moves along one of the two shafts (22) on which the switching member 25 is positioned, and the switching member 25 is limited to move between the connecting member 26 and the base 21. The connecting member 26 provides an external member (not shown in drawings) for assembly and connection, and although the connecting member 26 is mounted on one of the two shafts (22) together with the switching member 25, the connecting member 26 does not have a direct driving relationship with one of the two shafts (22), that is, when the connecting member 26 rotates, one of the two shafts (22) provided the connecting member 26 for assembly does not necessarily rotate simultaneously.

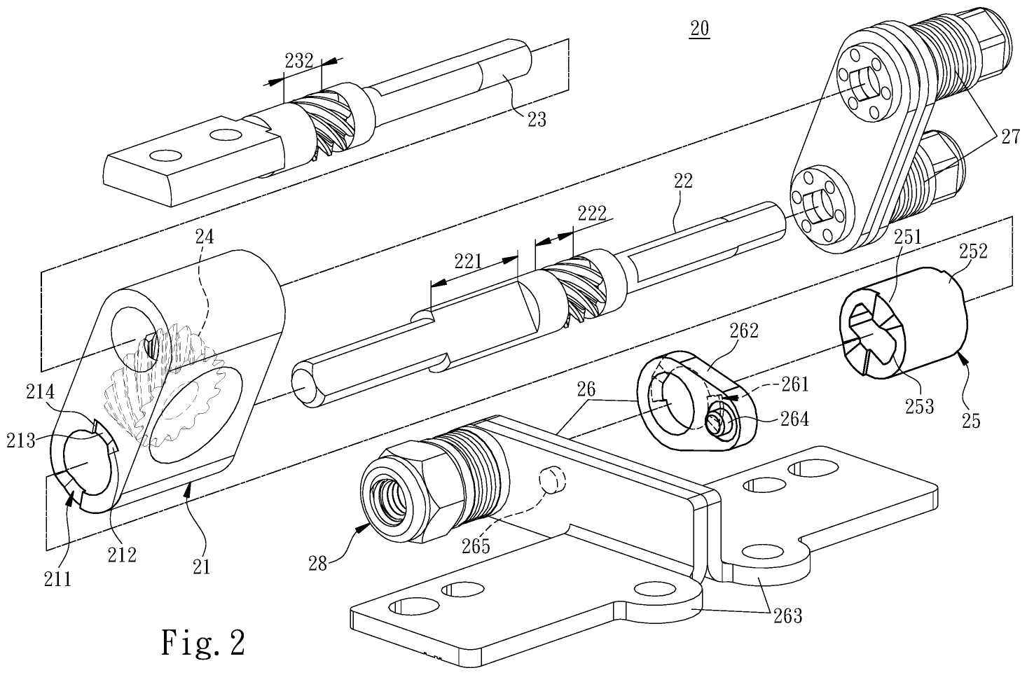

Referring FIG. 2 and FIG. 3, the switching member 25 includes two first concave-convex portions 251, 252 positioned at two ends thereof and respectively face the connecting member 26 and the base 21, the connecting member 26 includes a second concave-convex portion 261 facing the switching member 25 and t matched with one of the two first concave-convex portions (251), the base 21 includes a third concave-convex portion 211 facing the switching member 25 and matched with one of the two first concave-convex portions (252). Referring to FIG. 3 together, according to the present invention, the switching member 25 only includes two states along with a rotation angle of the double-shaft hinge 20: one state is that one of the two first concave-convex portions (251) of the switching member 25 is buckled with the second concave-convex portion 261; and the other state is that one of the two first concave-convex portions (252) of the switching member 25 is buckled with the third concave-convex portion 211. Based on the two states, the double-shaft hinge 20 includes a single-shaft implementation mode and a double-shaft implementation mode. In the single-shaft implementation mode, the connecting member 26 is only rotated relative to one of the two shafts (22) when one of the two first concave-convex portions (252) is buckled with the third concave-convex portion 211. In the double-shaft implementation mode, the two shafts 22, 23 are synchronously rotated when one of the two first concave-convex portions (251) is buckled with the second concave-convex portion 261. If the second concave-convex portion 261 and the third concave-convex portion 211 are viewed perspectively from one end of each of the two shafts 22, 23, it can be found that the second concave-convex portion 261 and the third concave-convex portion 211 do not overlap, so that buckling points of the second concave-convex portion 261, the third concave-convex portion 211 and the two first concave-convex portions 251, 252 are different (namely, at different opening angles of the double-shaft hinge 20).

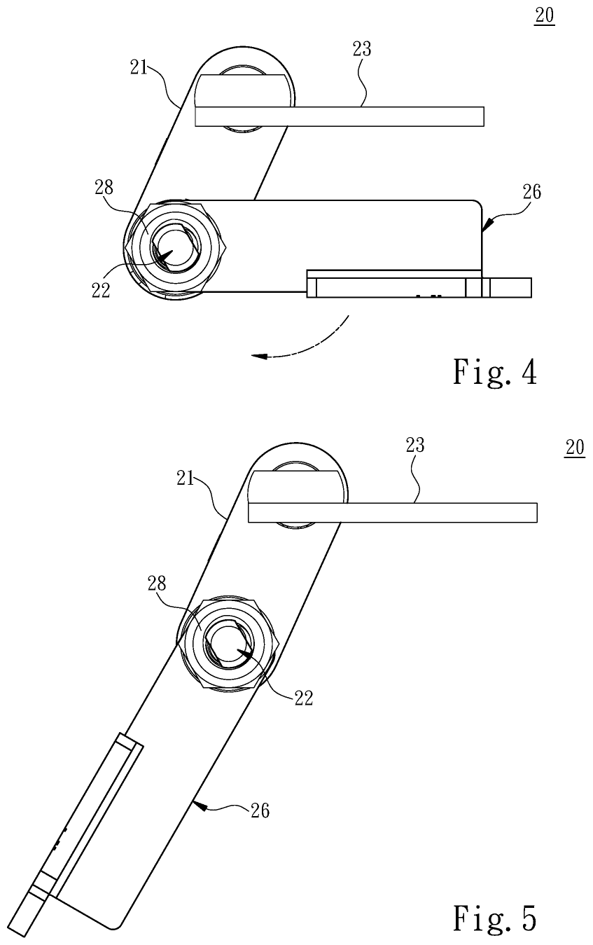

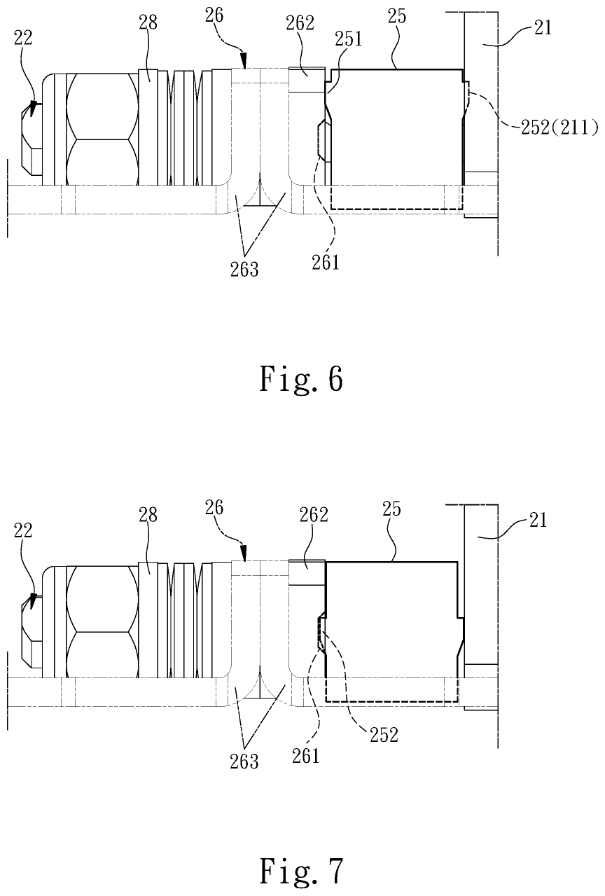

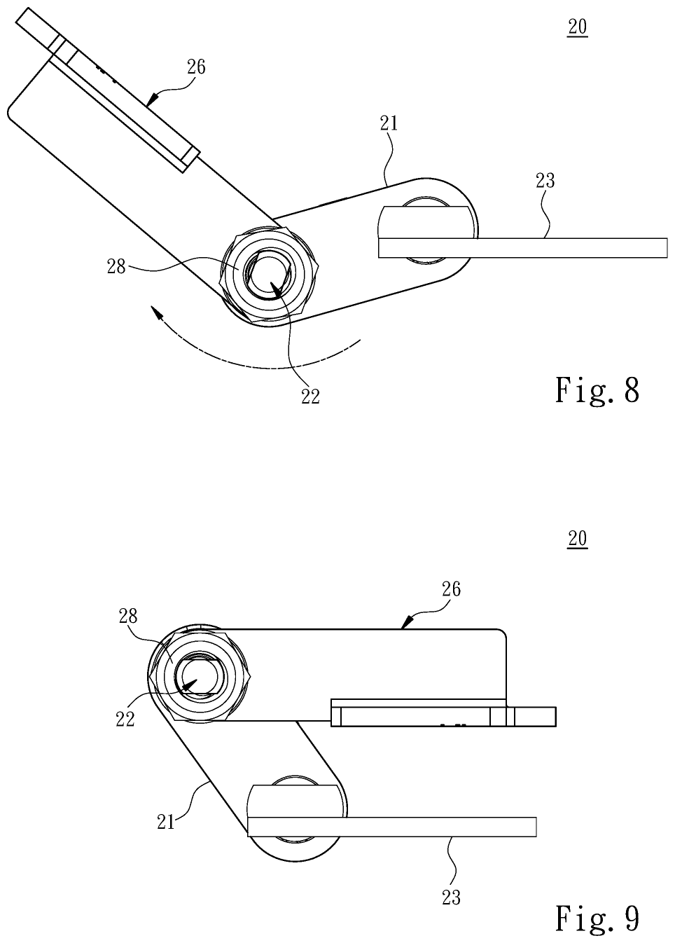

Referring to FIG. 4, FIG. 5, FIG. 6, FIG. 7, FIG. 8 and FIG. 9, according to the present invention, the double-shaft hinge 20 is implemented in a 360-degree opening. For specific description, FIG. 4 is described as an initial state (namely, in an 0-degree state) herein. When the double-shaft hinge 20 is in the 0-degree state, one of the two first concave-convex portions (252) of the switching member 25 is buckled with the third concave-convex portion 211, and the double-shaft hinge 20 is in the single-shaft implementation mode. At this stage, the connecting member 26 is driven by the external structure to rotate, and a rotation of the connecting member 26 at this stage cannot drive one of the two shafts (22). Specifically, one of the two shafts (22) is limited by the switching member 25 and cannot rotate at this stage, and the limitation of the switching member 25 is achieved by buckling of one of the two first concave-convex portions (252) and the third concave-convex portion 211. When the connecting member 26 continuously rotates to 120 degrees (namely, FIG. 5), the second concave-convex portion 261 enters a position where the second concave-convex portion 261 can be buckled with one of the two first concave-convex portions (251) of the switching member 25 along with the rotation of the connecting member 26, a force applied by a user to the double-shaft hinge 20 can rotate one of the two shafts 22, 23 which is not provided with the switching member 25, and synchronously rotate the two shafts 22, 23 at this time point. Upon the two shafts 22, 23 synchronously rotating, the switching member 25 is displaced on one of the two shafts (22) under an action, and one of the two first concave-convex portions (251) is buckled with the second concave-convex portion 261, as shown in FIG. 6 and FIG. 7. Further, the switching member 25 is engaged with the connecting member 26 to rotate the connecting member 26 by buckling of one of the first concave-convex portions (251) and the second concave-convex portion 261. After the double-shaft hinge 20 is opened to 120 degrees, the double-shaft implementation mode is maintained until a 360-degree rotation is completed (as shown in FIG. 8 and FIG. 9). According to the present invention, a reverse implementation of the above description is to close the double-shaft hinge 20, and will not be described in detail herein.

Referring to FIG. 2, in an example, one of the two shafts 22, 23 provided with the switching member 25 includes a non-circular section 221 assembled and connected with the switching member 25, and the switching member 25 includes a non-circular hole 253 corresponding to the non-circular section 221. Also, the non-circular hole 253 is a part of a space formed by the tubular structure of the switching member 25. Furthermore, the non-circular section 221 of one of the two shafts 22, 23 provided with the switching member 25 can be implemented by cutting off a portion of a circular, and the non-circular section 221 is preferably designed to correspond to the non-circular hole 253.

Referring to FIG. 1, in an example, the double-shaft hinge 20 includes two first torsion generating groups 27 respectively arranged on the two shafts 22, 23, and a second torsion generating group 28 arranged on one of the two shafts 22, 23 provided with the switching member 25. The two composition of the first torsion generating groups 27 and the second torsion generating group 28 can be implemented by selecting a corresponding structure according to implementation requirements, and the present invention is not limited thereto. Furthermore, when the double-shaft hinge 20 is in the single-shaft implementation mode, one of the two first concave-convex portions (251) of the switching member 25 abuts against a surface of the connecting member 26, the connecting member 26 is pressed by the second torsion generating group 28 to generate a torsion required for rotation of the connecting member 26 in this mode.

Referring to FIG. 2, FIG. 3, FIG. 6 and FIG. 7, in an example, the two first concave-convex portions 251, 252, the second concave-convex portion 261 and the third concave-convex portion 211 are respectively provided with one of the following: at least two bumps and at least two grooves. In an example illustrated by the drawings of the present invention, the two first concave-convex portions 251, 252 are respectively provided with the at least two bumps, and the second concave-convex portion 261 and the third concave-convex portion 211 are respectively provided with the at least two grooves. Further, in an example, each of the at least two grooves includes a guide inclined surface 212, a groove bottom surface 213 connected to the guide inclined surface 212, and a blocking surface 214 connected to the groove bottom surface 213. Further, the at least two bumps are designed to correspond to the at least two grooves, and positions of the at least two blocking surfaces 214 of the at least two grooves are set according to an opening rotation direction of one of the two shafts (22). More specifically, when each of the at least two bumps disengages with one of the at least two grooves, each of the at least two bumps contacts the at least two grooves in an order of the guide inclined surface 212, the groove bottom surface 213, and the blocking surface 214, and when the at least two bumps contacts the at least two blocking surfaces 214 of the at least two grooves, the above-mentioned description of buckling is completed. When one of the two shafts (22) rotates in a closing rotation direction, each of the at least two bumps sequentially releases the blocking surface 214, the groove bottom surface 213, and the guide inclined surface 212.

Referring to FIG. 2, in an example, the driving member 24 is a spiral gear, and each of the two shafts 22, 23 includes a threaded section 222, 232 matched with the driving member 24.

Referring to FIG. 1 and FIG. 2, in an example, the connecting member 26 includes a plurality of plates 262, 263, and the second concave-convex portion 261 is formed on one of the plurality of plates 262, 263 facing the switching member 25. Further, one of the plurality of plates 262, 263 provided with the second concave-convex portion 261 further includes a driving portion 264 for driving the other adjacent one of the plurality of plates 262, 263, and the other adjacent one of the plurality of plates 262, 263 assembled and connected with the driving portion 264 includes a mounting portion 265. Also, the driving portion 264 can be a pin, while the mounting portion 265 can be a through hole for disposal of the pin.

What is claimed is:

1. A double-shaft hinge with single-shaft implementation mode, comprising a base, two shafts arranged on the base in parallel, and a driving member synchronously rotating the two shafts, characterized by that:
one of the two shafts is provided with a switching member and a connecting member, the switching member is provided for driving one of the two shafts, on which the switching member is positioned, to rotate, the switching member is limited to move between the connecting member and the base, the switching member comprises two first concave-convex portions positioned at two ends thereof and respectively facing the connecting member and the base, the connecting member comprises a second concave-convex portion facing the switching member and matched with one of the two first concave-convex portions, the base comprises a third concave-convex portion facing the switching member and matched with the other one of the two first concave-convex portions, the double-shaft hinge comprises a single-shaft implementation mode and a double-shaft implementation mode; in the single-shaft implementation mode, the connecting member is only rotated relative to one of the two shafts when one of the two first concave-convex portions is buckled with the third concave-convex portion; and in the double-shaft implementation mode, the two shafts are synchronously rotated when one of the first concave-convex portions is buckled with the second concave-convex portion.

2. The double-shaft hinge with single-shaft implementation mode according to claim 1, wherein one of the two shafts provided with the switching member comprises a non-circular section assembled and connected with the switching member, and the switching member comprises a non-circular hole corresponding to the non-circular section.

3. The double-shaft hinge with single-shaft implementation mode according to claim 2, wherein the double-shaft hinge comprises two first torsion generating groups respectively arranged on the two shafts, and a second torsion generating group arranged on one of the two shafts provided with the switching member.

4. The double-shaft hinge with single-shaft implementation mode according to claim 3, wherein the two first concave-convex portions, the second concave-convex portion, and the third concave-convex portion are respectively provided with one of the following: at least two bumps and at least two grooves.

5. The double-shaft hinge with single-shaft implementation mode according to claim 4, wherein each of the at least two grooves comprises a guide inclined surface, a groove bottom surface connected to the guide inclined surface, and a blocking surface connected to the groove bottom surface.

6. The double-shaft hinge with single-shaft implementation mode according to claim 3, wherein the driving member is a spiral gear, and each of the two shafts comprises a threaded section matched with the driving member.

7. The double-shaft hinge with single-shaft implementation mode according to claim 2, wherein the connecting member comprises a plurality of plates, and the second concave-convex portion is formed on one of the plurality of plates facing the switching member.

8. The double-shaft hinge with single-shaft implementation mode according to claim 7, wherein one of the plurality of plates provided with the second concave-convex portion further comprises a driving portion for driving the other adjacent one of the plurality of plates, and the other adjacent one of the plurality of plates assembled and connected with the driving portion comprises a mounting portion.
